(19) United States
(12) Patent Application Publication
(10) Pub. No.: US 2017/0046633 A1
(43) Pub. Date: Feb. 16, 2017

(54) GROUP-BASED LEAD MANAGEMENT PLATFORM

(71) Applicant: Cvent, Inc., Tysons Corner, VA (US)

(72) Inventors: Daniel RUSSOTTO, Tysons Corner, VA (US); Brian Gauthier, Tysons Corner, VA (US); Jeffrey O. Emenecker, Tysons Corner, VA (US); Alex Whitney, Tysons Corner, VA (US)

(73) Assignee: Cvent, Inc., Tysons Corner, VA (US)

(21) Appl. No.: 14/826,933

(22) Filed: Aug. 14, 2015

(51) Int. Cl. G06Q 10/02

(52) U.S. Cl. CPC G06Q 10/02

(57) ABSTRACT

A group-based lead management platform can efficiently manage and score leads for suppliers such as hotels. The platform can manage leads in a separate layer above the underlying systems that controls inventory. The platform can automatically adjust lead scoring strategy based on the pace of inventory booking relative to plan. The platform can take into account historical booking patterns of a supplier in generating lead scores. The platform can auto-assign or estimating one or more events associated with a group booking to one or more units of event space. The platform can provide a lead score in a user interface that also provides a visual breakdown of the scoring strategy components weighting the score.

### FIELD OF THE DISCLOSURE

This relates to lead management over computer networks, including group lead management and group lead scoring for inventory units such as hotel sleeping rooms, meeting and event space (e.g., in hotel and/or other venues), and ancillary services related to meetings and events.

### BACKGROUND

In the “brick and mortar” context prior to the Internet era, suppliers of goods or services relied on manual and time-consuming methods of handling business leads. Leads refer to indications of interest in a supplier's goods or services, such as requests for proposal.

A request for proposal (RFP) is a document inviting suppliers of goods or services to propose terms for providing a specific good or service. For example, an RFP in the hospitality industry might comprise an invitation to hotels to accommodate a predetermined number of guests for a predetermined length of time and to provide facilities for the guests to have a scheduled conference. Often the suppliers of goods or services provide forms for buyers used to submit an RFP. Accordingly, buyers are presented with a wide and disparate range of RFP submission forms and response processes. Typically, these buyers manually fill out the RFP forms and submit them to the suppliers individually.

With the advent of the Internet era, the world has become more connected and electronic communication has exploded, resulting in some sellers receiving unmanageable numbers of leads. These sellers can employ yield management and revenue management systems to help process the leads, but they often manually input the data from the received leads into corporate sales systems, such as yield management and revenue management systems, to generate electronic responses, which is a very time consuming process. Even if some automation exists, it is typically siloed across revenue streams (e.g., separate systems for sleeping rooms vs. meeting and event space).

Further, such sales systems are very poor at making it easy for a supplier to understand how certain business characteristics, such as profitability, change based on changing specific parts of the lead. In industries such as the hospitality industry that hold inventory for booking (e.g., the reserving of inventory units such as hotel rooms, golf tee times, spa treatments, conference rooms, ballrooms, etc.), such sales systems force the suppliers to work through the physical booking that affects inventory. This means that if the supplier changes a specific part of a lead in the sales system to see how a business characteristic changes, the inventory associated with the original lead becomes unblocked (e.g., unreserved or available for someone else's use) and the inventory associated with the modified lead becomes blocked (e.g., reserved or unavailable for someone else's use).

Due to the complexity and interdependencies of the many systems that rely on a supplier's sales system and inventory, this process can cause such sales systems to become disjointed. This effect becomes especially pronounced when dealing with group bookings (e.g., a booking for an entity—e.g., a business or organization—or multiple individuals), which tend to effect large blocks of inventory.

### SUMMARY

A group-based lead management platform is disclosed. The platform disclosed herein can efficiently manage and score leads for suppliers such as hotels. For example, hoteliers are burdened with processing an estimated 15 million leads per year and need to make sure that they are focused on the biggest and best opportunities. The platform can not only help hotels identify leads with the highest profit potential in isolation, but also assess how well the lead will “fit” into the hotel based on groups already committed and forecasted. In addition, it can also give hotels the tools they need to manage those leads in a manner that maximizes their chance of winning the business. Helping suppliers prioritize, manage and respond to those leads allows them to focus on the most profitable opportunities.

The platform can accomplish this in several ways. By managing leads in a separate layer above the underlying systems that controls inventory, the platform can help sales people evaluate what-if booking scenarios pertaining to a received lead (e.g., evaluating alternative dates for a booking) in a quick and efficient manner without impacting inventory. By automatically adjusting lead scoring strategy based on the hotel pace and contracted inventory already “on-the-books” of a given lead's arrival date, the platform can provide suppliers with more accurate lead scores that are dynamically tuned to the current status of their inventory. By taking into account historical booking patterns of a supplier in generating lead scores, the platform can efficiently and accurately score leads in a manner that is customized to the best fit of the supplier. By auto-assigning or estimating one or more events associated with a group booking to one or more units of event space, the platform can provide event space optimization that saves sales people vast amounts of time in quickly and efficiently evaluating which units are the best fit for the group's events. By providing a lead score in a user interface that also provides a visual breakdown of the scoring strategy components weighting the score, across single or multiple properties, the platform can provide suppliers with a quick and informative indication as to how the received lead earned the score it was given.

### BRIEF DESCRIPTION OF THE DRAWINGS

FIG. 1 illustrates an example of a system architecture for a lead management platform.

FIG. 2 illustrates an example of a lead management process.

FIG. 3 illustrates an example of lead scoring over a network.

FIG. 4 illustrates an example of a pacing based lead scoring process.

FIG. 5 illustrates an example of a pattern fit based lead scoring process.

FIG. 6 illustrates an example of an auto-assignment lead management process.

FIG. 7 illustrates an example of lead scoring user interface process.

FIGS. 8-16 illustrate examples of lead management user interfaces.

FIG. 17 illustrates an example of a computing device.

### DETAILED DESCRIPTION

The present disclosure is directed to a group-based lead management platform. Although the embodiments disclosed herein describe lead management in the context of the hospitality industry, the lead management platform is not so limited and can be used to provide lead management for any type of industry that holds inventory for booking, such as the car rental or real estate industry, in accordance with the teachings of the present disclosure.

The platform disclosed herein can efficiently manage and score leads for suppliers such as hotels. For example, hoteliers are burdened with processing an estimated 15 million leads per year and need to make sure that they are focused on the biggest and best opportunities. The platform can help hotels identify leads with the highest profit potential and also give them the tools they need to manage those leads in a manner that maximizes their chance of winning the business. Helping suppliers prioritize, manage and respond to those leads allows them to focus on the most profitable opportunities.

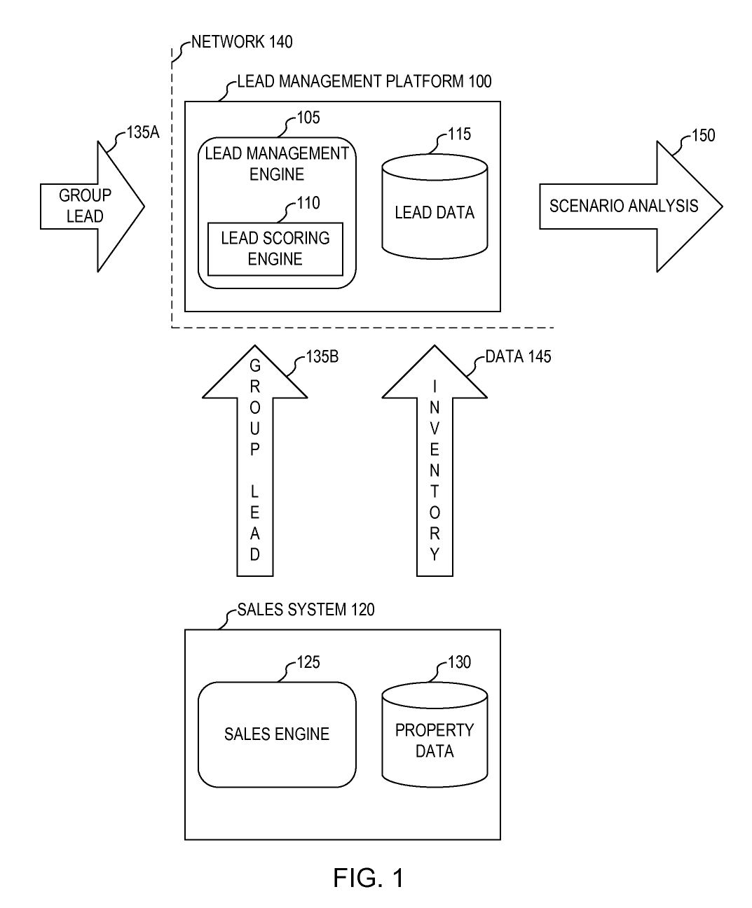

FIG. 1 illustrates an example of a system architecture for a lead management platform. In the illustrated embodiment a supplier can utilize lead management platform 100 and sales system 120 to control and manage one or more of the supplier's properties that comprise inventory for booking.

Lead management platform 100 can comprise lead management engine 105, which can also comprise lead scoring engine 110, and lead data 115. Lead management platform 100 can comprise a computer system deployable in any suitable architecture, such as local (e.g., standalone), remote (e.g., cloud-based) or a combination of the two (e.g., client/server). Lead management engine 105 and lead scoring engine 110 can comprise application software (e.g., one or more software programs and/or modules) configured to operate in accordance with the present disclosure, and can be coupled to lead data 115 which can comprise any suitable data store that can store information used by lead management engine 105 and lead scoring engine 110.

Sales system 120 can comprise sales engine 125 and property data 130. Sales system 120 can comprise a computer system configured to manage and control inventory of a supplier, such as a hotel and catering system, yield management system and/or revenue management system. Sales engine 125 can comprise application software (e.g., one or more software programs and/or modules) configured to manage and control inventory, and can be coupled to property data 130 which can comprise any suitable data store that can store information used by sales engine 125 such as inventory. Property data 130 can also store any suitable data useful for setting up lead management platform 100 for a particular supplier, such as metrics, physical configuration of inventory, etc. This information and other information, such as pacing data and supplier business data (e.g., margins, etc.), can be part of property data 130, lead data 115, and/or obtained from third party sources.

Pacing data refers to data that specifies the extent to which inventory is booked (e.g., reserved) relative to plan at any particular time. For example, if a hotel plans that 50% of its rooms are to be reserved six months out, but at the current time 55% of the rooms are reserved six months out, then the room bookings are considered to be pacing ahead of schedule. Conversely, if at the current time 45% of the rooms are reserved six months out, then the room bookings are considered to be pacing behind schedule. If at the current time 50% (plus or minus a suitable margin) of the rooms are reserved six months out, then the room bookings are considered to be on pace.

When sales engine 125 itself manages inventory in property data 130, e.g., makes or holds a booking, the inventory can become blocked due to the transactional nature of the system. Therefore, to avoid impacting (e.g., blocking) inventory, lead management platform 100 can be configured to receive one or more group leads 135 over network 140 and, based on data 145 received from sales system 120 (e.g., inventory data) and additional configuration data from lead data 115, provide scenario analysis 150, such as a proposed group booking, for each lead without blocking inventory associated with the lead in sales system 120. By managing leads in a separate layer above the underlying systems that controls inventory, the platform can help sales people evaluate what-if booking scenarios pertaining to a received lead in a quick and efficient manner without impacting inventory. Lead management platform 100 can receive group leads from sales system 120 via sales engine 125 (e.g. group lead 135B) and/or other sources, such as the source of the lead (e.g., group lead 135A).

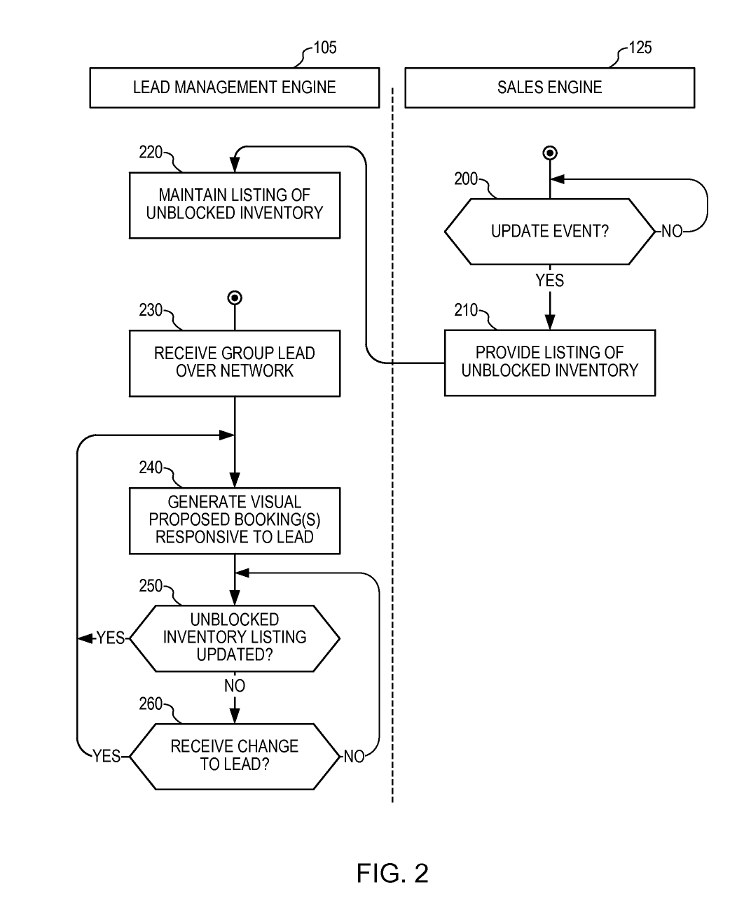

FIG. 2 illustrates an example of a lead management process that manages leads without impacting inventory. In the illustrated embodiment sales engine 125 can be configured to provide a listing of unblocked inventory to lead management engine 105 (block 210) upon an update event (block 200). The update event can comprise any suitable event that allows sales system 120 to provided inventory updates to lead management platform 100 within a reasonable time, such as in real time (e.g., via a data feed or stream), near real time (e.g., at predetermined time intervals such as within every hour, half-hour, 10 minutes, 5 minutes, etc.), or in response to a change in inventory. The listing can be provided in any suitable form, such as a complete listing of unblocked inventory and/or only updates to previously provided inventory data. In this manner lead management engine 105 can receive and maintain (block 220) a listing of current unblocked inventory of one or more of the supplier's properties.

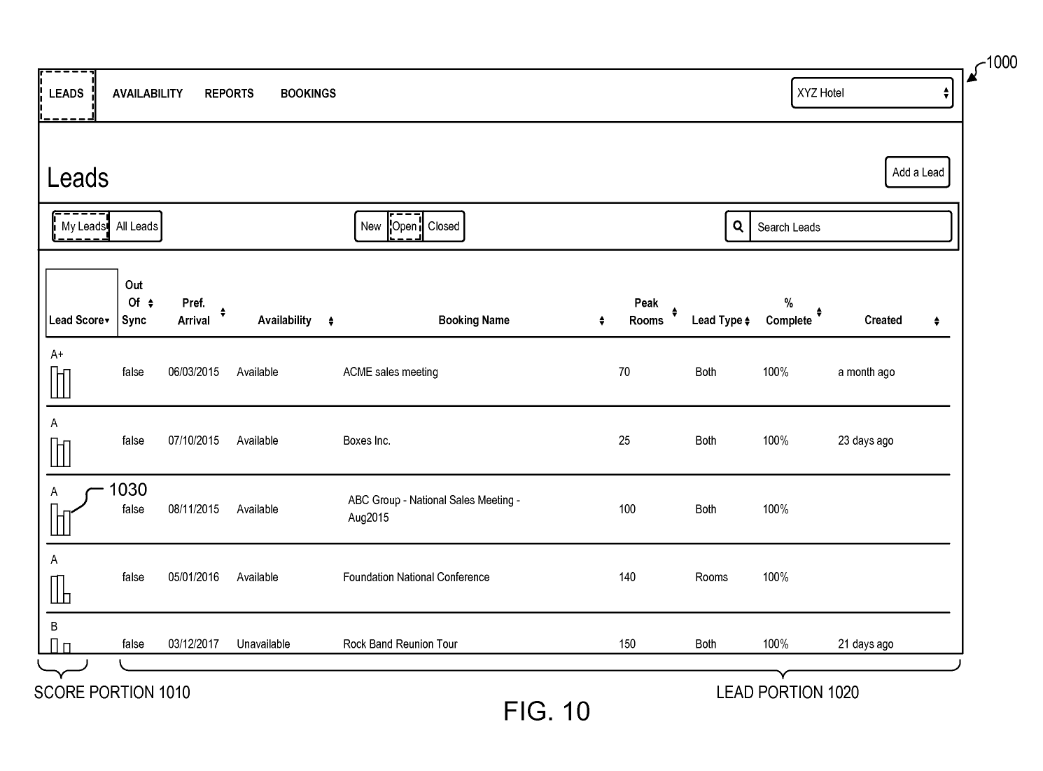

Lead management engine 105 can receive (block 230) a lead over network 140 (e.g., from sales system 120 or another source). The lead can comprise any suitable electronic format and specify an interest in a group booking of at least a portion of the inventory. Lead management engine 105 can generate (block 240) one or more visual proposed bookings responsive to the lead. This can be implemented, for example, by generating one or more proposed group bookings based on the received listing without blocking the inventory associated with the one or more proposed group bookings and displaying the generated one or more proposed group bookings via a user interface, such as user interface 1000 shown in FIG. 10.

Upon receiving an update to the listing of inventory (block 250), lead management engine 105 can automatically, in response to the received update, generate (block 240) one or more updated proposed group bookings based on the updated listing without blocking the inventory associated with the one or more updated proposed group bookings, and display the generated one or more updated proposed group bookings via the user interface.

Upon receiving a change to the lead via the user interface (block 260), e.g., by a sales person of the supplier changing one or more of the terms of the leads, lead management engine 105 can automatically, in response to the received change, generate (block 240) one or more updated proposed group bookings based on the changed lead without blocking the inventory associated with the one or more updated proposed group bookings, and display the generated one or more updated proposed group bookings via the user interface. Blocks 250 and 260 can be executed in any order (e.g., block 260 can be executed before block 250) or, in an alternative embodiment, one can be executed to the exclusion of the other.

In the illustrated embodiment lead management platform 100 is configured to pull data from sales system 120 but not to push data to sales system 120. In another embodiment lead management platform 100 can also be configured to push data (not shown) to sales system 120. For example, to avoid the risk of a sales person losing a booking to someone else while evaluating what-if scenarios, lead management engine 105 can generate, in response to the received lead, a proposed group booking, based on the received listing, that blocks the inventory associated with the proposed group booking (e.g., by sending a booking instruction to sales engine 125), and display the generated group booking via the user interface. To assist a sales person in evaluating what-if scenarios (e.g., evaluating alternative dates for a booking), lead management engine 105 can generate other proposed group bookings associated with the lead without blocking the inventory (e.g., by not sending any booking instruction to sales engine 125) as described above.

It is noted that although lead management platform 100 is shown in this embodiment as comprising a computer system distinct from sales system 120, in other embodiments lead management platform 100 can also comprise sales system 120 or its functional equivalent without departing from the teachings of the present disclosure.

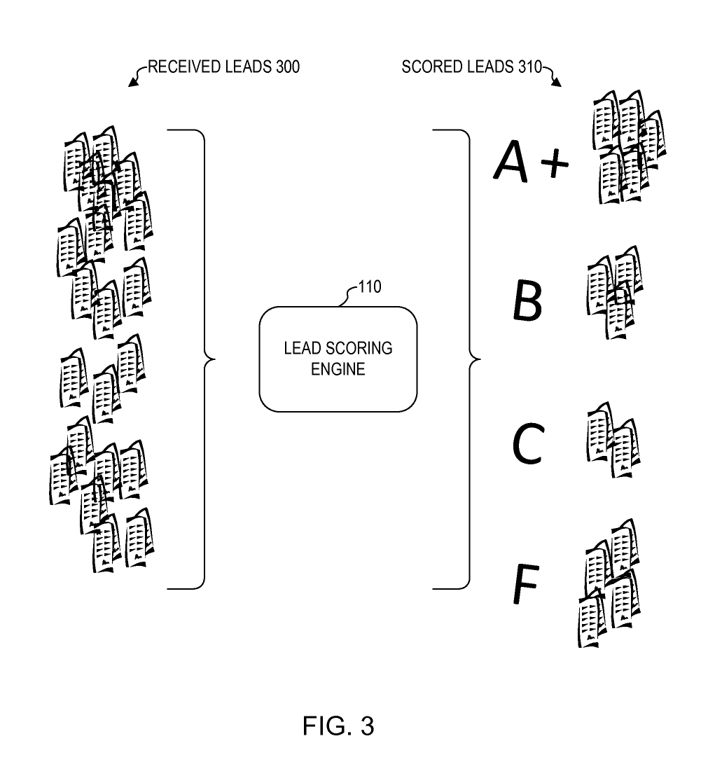

FIG. 3 illustrates an example of lead scoring over a network. As shown in the illustrated embodiment, lead scoring engine 110 inputs received leads 300 and outputs scored leads 310. Scoring can be based on any suitable scoring system, such as a letter scale (e.g., an “A” to “F” scale with “A” or its variants “A+” or “A−” for example indicating the best grade) or a number scale. Scoring can qualify the quality of received leads 300, how well they match the financial aspirations of the supplier, and how well the lead fits into the physical inventory in light of what's already contract and/or forecasted.

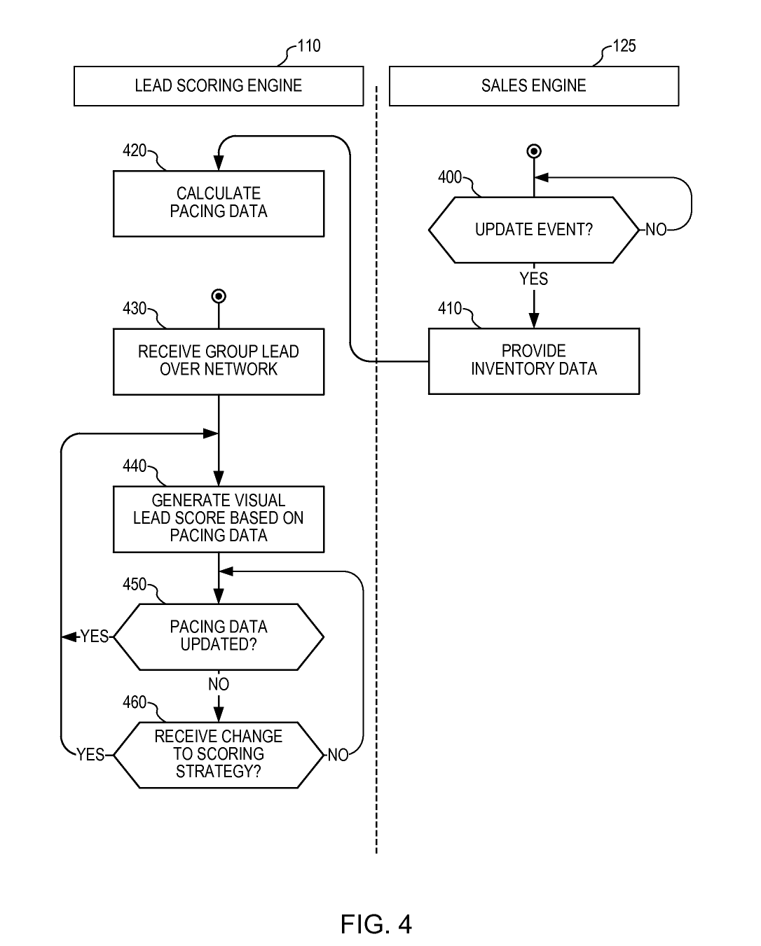

FIG. 4 illustrates an example of a pacing based lead scoring process. By configuring the lead scoring strategy based on the pace of inventory booking relative to plan (e.g., implement strategy x vs strategy y for a given lead based on the “pace”), lead management platform 100 can provide suppliers with more accurate lead scores that are dynamically tuned to the current status of their inventory.

In the illustrated embodiment sales engine 125 can be configured to provide inventory data to lead scoring engine 110 (block 410) upon an update event (block 400) so that pace data can be calculated (block 420). The update event can comprise any suitable event that allows sales system 120 to provided inventory data updates to lead management platform 100 within a reasonable time, such as in real time (e.g., via a data feed or stream), near real time (e.g., at predetermined time intervals such as within every hour, half-hour, 10 minutes, 5 minutes, etc.), or in response to a change in the pace of inventory booking. The inventory can be provided in any suitable form that can allow lead scoring engine 110 to calculate whether the supplier's inventory booking is behind pace, on pace or ahead of pace. In this manner lead scoring engine 110 can receive and maintain (block 420) an indication of the current pace of inventory booking of one or more of the supplier's properties relative to plan. In an alternative embodiment the pacing data can be calculated outside of lead management platform 100 and provided to lead management platform 100.

Lead scoring engine 110 can receive (block 430) a lead over network 140 (e.g., from sales system 120 or another source). The lead can comprise any suitable electronic format and specify an interest in a group booking of at least a portion of the inventory. Lead scoring engine 110 can generate (block 440) a visual lead score based on the pacing data. This can be implemented, for example, by generating a score for the received lead based on a preconfigured scoring strategy comprising the calculated pacing data and displaying the generated score via a user interface, such as user interface 1000 shown in FIG. 10.

Upon receiving an update to the pacing data (block 450), lead scoring engine 110 can automatically, in response to the received update, generate (block 440) an updated score for the received lead based on the updated pacing data, and display the generated updated score via the user interface.

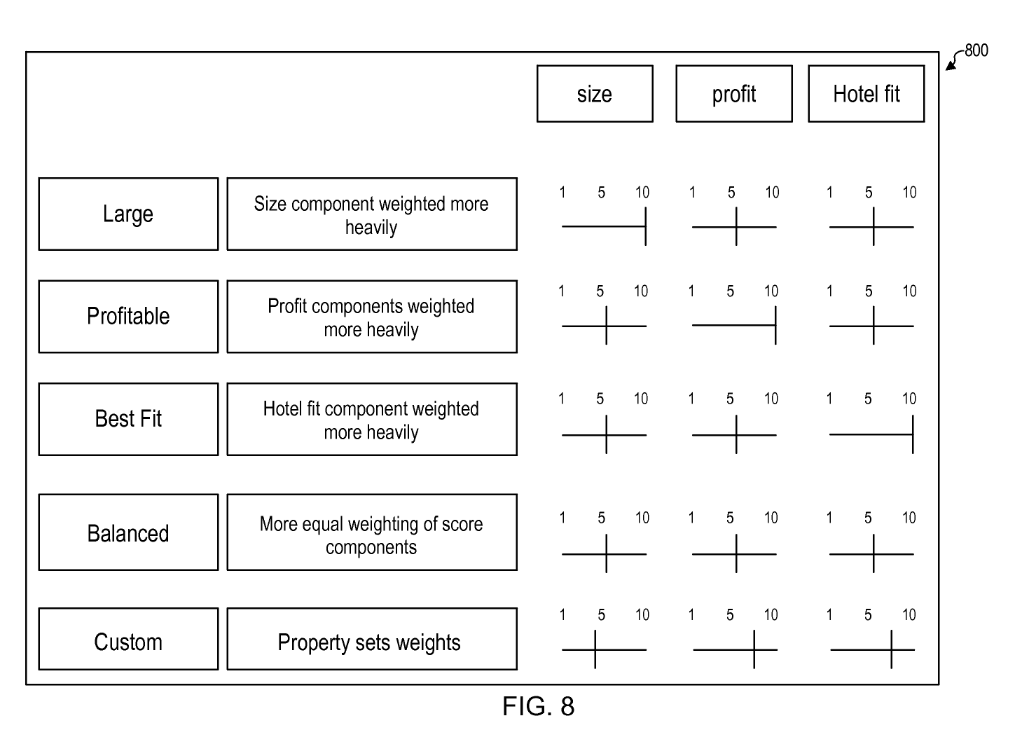

Upon receiving a change to the scoring strategy via the user interface (block 460), e.g., by a sales person of the supplier changing one or more of the components of the leads such as the size of booking weighting, profitability of booking weighting or property fit weighting as shown in user interface 800 of FIG. 8, lead scoring engine 110 can automatically, in response to the received change, generate (block 440) an updated score for the received lead based on the changed scoring strategy, and display the generated updated score via the user interface. Blocks 450 and 460 can be executed in any order (e.g., block 460 can be executed before block 450) or, in an alternative embodiment, one can be executed to the exclusion of the other.

Further, the process of FIG. 4 need not include block 460. In such an embodiment the various scoring strategies can be pre-configured one time, specifying which strategy is to be implemented based on pace, for all incoming leads.

Lead scoring components can comprise any suitable variable or parameter for scoring a lead. A size component can take into account aspects such as room night size and total revenue. A profit component can take into account aspects such as profit per room night, profit per square foot daypart, and total revenue. A property fit component can take into account aspects such as group pace, space/guest room ratio and pattern fit. Additional components can comprise a low occupancy component, a sleeping room availability component, a meeting space availability component, probability of close and total expected value.

Further, scoring components with respect to group variables can comprise size of booking, repeat group (indicator), space-to-guestroom ratio (SGR), long term value, account relationship, market industry/segment, and contractual expectations—wash/cancel. Scoring components with respect to market variables can comprise low occupancy rate, seasonality, current market compression, and remaining demand. Scoring components with respect to search and planner variables can comprise % data provided (indicator), date flexibility (indicator), # of markets searched, # of hotels searched, pattern flexibility, planner likelihood to award, planner brand preference, and booking window. Scoring components with respect to hotel variables can comprise availability, total profitability, group pace, rate closeness, displacement, and need dates.

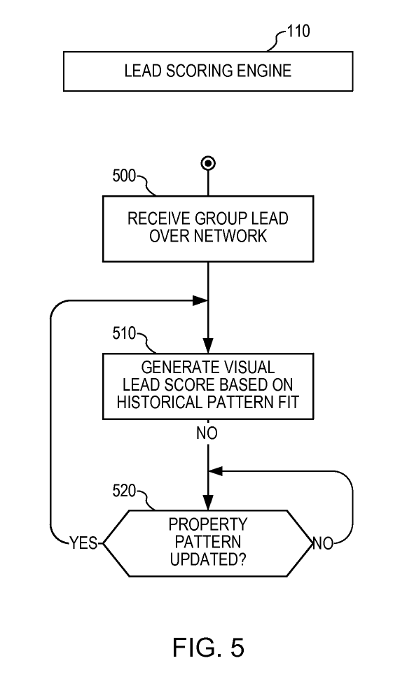

FIG. 5 illustrates an example of a pattern fit based lead scoring process. By taking into account historical booking patterns or configurable booking patterns (e.g., desire to book differently than historical) of a supplier in generating lead scores, the platform can efficiently and accurately score leads in a manner that is customized to the best fit of the supplier.

In the illustrated embodiment lead scoring engine 110 can receive (block 500) a lead over network 140 (e.g., from sales system 120 or another source). The lead can comprise any suitable electronic format and specify an interest in a group booking of at least a portion of inventory associated with one or more properties. Lead scoring engine 110 can generate (block 510) a visual lead score based on a historical pattern fit tailored to the one or more properties. This can be implemented, for example, by comparing the received lead against a historical booking pattern associated with the one or more properties, generating a score for the received lead based on the comparison of the received lead against the historical booking pattern, and displaying the generated score via a user interface. Industry knowledge on booking patterns from outside the one or more properties can also be used in the comparison.

Historical booking patterns can be mined from any suitable data source, such as prior booking activity used by lead management platform 100 and stored in lead data 115 and/or prior booking activity received from other sources such as property data 130 of sales system 120. The comparison and scoring can be implemented by any suitable statistical or analytics based algorithm. The booking pattern can relate to any suitable criteria tailored to the operation of the supplier, such as probabilities associating group bookings of distinct sizes with distinct days of the week.

For example, assume lead scoring engine 110 determines from the supplier's history that particular types of groups have rented most of the supplier's hotel during a particular week from Monday through Thursday. With this determination, lead scoring engine 110 can evaluate that a lead from a group that wishes to rent most of the supplier's hotel during that particular week for only Tuesday and Wednesday would not be a good pattern fit, because that booking would make it difficult to find a group to rent most of the hotel on only Monday and Thursday of that week. Lead scoring engine 110 can reflect this poor fit in the generated lead score.

Upon receiving an update to a pattern associated with the one or more properties (block 520), lead scoring engine 110 can generate (510) an updated score for the received lead. For example, lead scoring engine 110 can receive an update to the historical booking pattern (e.g., via data 145 from sales system 120 that comprises new booking data reflecting a different booking pattern), and, automatically in response to the received update, generate an updated score for the received lead based on the updated historical booking pattern, and display the generated updated score via the user interface.

Additionally or alternatively, lead scoring engine 110 can receive a change to a scoring strategy (e.g., reflecting a pattern desired by the hotel moving forward) via the user interface, such as user interface 1000 shown in FIG. 10, and, automatically in response to the received change, generate an updated score for the received lead based on the changed scoring strategy and display the generated updated score via the user interface.

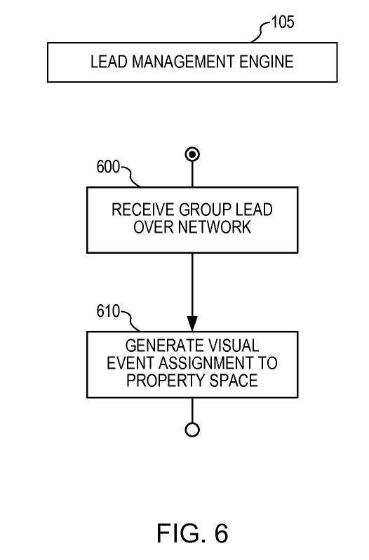

FIG. 6 illustrates an example of an auto-assignment lead management process. By auto-assigning or estimating one or more events associated with a group booking to one or more units of event space (e.g., inventory units such as conference rooms and/or ballrooms), the platform can provide event space optimization that saves sales people vast amounts of time in quickly and efficiently evaluating which units are the best fit for the group's events.

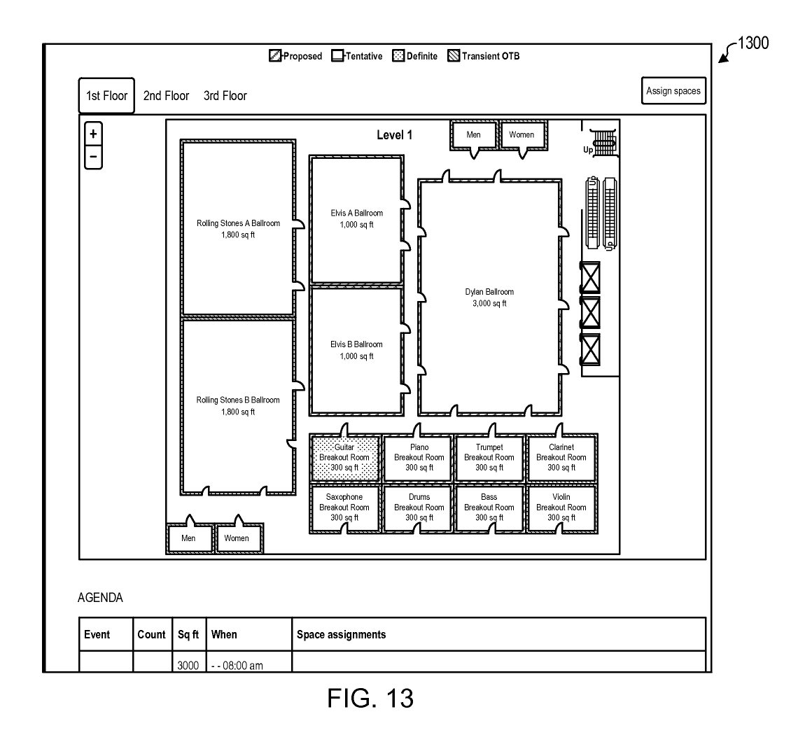

In the illustrated embodiment lead management engine 105 can receive (block 600) a lead over network 140 (e.g., from sales system 120 or another source). The lead can comprise any suitable electronic format and specify an interest in a group booking of at least a portion of event space associated with one or more properties. Lead management engine 105 can generate (block 610) a visual event assignment to property space. This can be implemented, for example, by determining a mapping of one or more events associated with the group booking to one or more units of the event space and displaying the generated mapping via a user interface, such as the user interface shown in FIG. 13. The mapping of the one or more events associated with the group booking may be determined using any suitable factor such as number of attendees and setup type.

FIG. 13 shows a layout corresponding to the event space and one or more user interface objects associated with the mapped one or more units of the event space. The user interface objects can comprise any suitable visual indication, such as highlighting, to identify the event space mapped by lead management engine 105 in association with a lead. When the user selects the “Assign spaces” button in the upper right-hand corner, for example, the user can override the auto-assignment made by lead management engine 105 by highlighting particular event space units and, upon saving, can determine the update impact to the lead score.

The mapping can be based on any suitable measure of space, such as square footage. The measure of event space of the one or more properties can be determined from any suitable source such as property data 130 and/or lead data 115. The measure of event space associated with the lead can be determined either explicitly (e.g., the amount of space needed is specified in the lead—either square footage or the product of attendee and setup type information) or implicitly (e.g., based on the history of event space typically used by similar groups in the past as derived from property data 130 and/or lead data 115).

The latter situation can occur when the received lead fails to specify an amount of event space for the group booking. In this situation lead management engine 105, in response to the received lead, can compare the received lead against a historical booking pattern associated with the one or more properties, generate an amount of event space for the group booking based on the comparison of the received lead against the historical booking pattern, and modify the lead to comprise the generated amount of event space. Industry knowledge on booking patterns from outside the one or more properties can also be used in the comparison. The comparison and event space amount generation can be implemented using any suitable statistical or analytics based algorithm.

Lead management engine 105 can also receive a change to the mapping via the user interface and generate a proposed group booking based on the changed mapping. For example, a sales person can reassign lead events to the event space using any suitable user interface technique, such as clicking and dragging highlighting from one event space to another in the layout shown in FIG. 13.

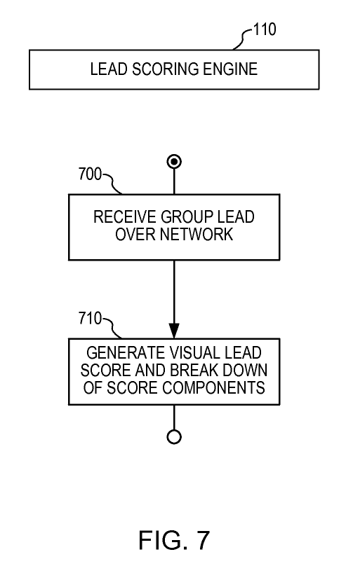

FIG. 7 illustrates an example of lead scoring user interface process. By providing a lead score in a user interface that also provides a visual breakdown of the scoring strategy components weighting the score, across single or multiple properties, the platform can provide suppliers with a quick and informative indication as to how the received lead earned the score it was given.

In the illustrated embodiment lead scoring engine 110 can receive (block 700) a lead over network 140 (e.g., from sales system 120 or another source). The lead can comprise any suitable electronic format and specify an interest in a group booking of at least a portion of inventory associated with one or more properties. Lead scoring engine 110 can generate (block 710) a visual lead score and breakdown of score components. This can be implemented, for example by generating, in response to the received lead, a score for the received lead based on a scoring strategy comprising multiple components, and displaying a user interface comprising a first portion comprising content corresponding to a proposed group booking based on the received lead, and a second portion comprising a user interface object corresponding to the multiple components of the generated score.

The user interface object can comprise any suitable visual indication, such as a graph or geometric shapes, to identify the visual breakdown of the scoring strategy components weighting the score. In the case of a graph, the user interface object can comprise a bar graph, in which each bar of the graph corresponds to a distinct one of the multiple components, and a height of each bar indicates an extent of the score relative to its respective component. In the case of geometric shapes, the user interface object can comprise a geometric shape corresponding to a distinct one of the multiple components, and a color, pattern or type of each geometric shape indicates an extent of the score relative to its respective component.

An example of such a user interface is shown by user interface 1000 in FIG. 10, in which lead portion 1020 (e.g., all columns of each row except for the leftmost column) comprises content corresponding to a proposed group booking based on the received lead, and score portion 1010 (e.g., the leftmost column of each row) comprises a user interface object (e.g., graph 1030) in the form of a bar graph corresponding to the multiple components of the generated score. Graph 1030, which relates to the “ABC Group” lead, shows the first bar as the highest (e.g., representing the weighting of the size component of the scoring strategy), the second bar as the lowest but still relatively high (e.g., representing the weighting of the profit component of the scoring strategy), and the third bar as in between the first and second bars (e.g., representing the weighting of the hotel fit component of the scoring strategy). The lead score (e.g., letter grades “A+,” “A” and “B”) is shown above the user interface object in score portion 1010.

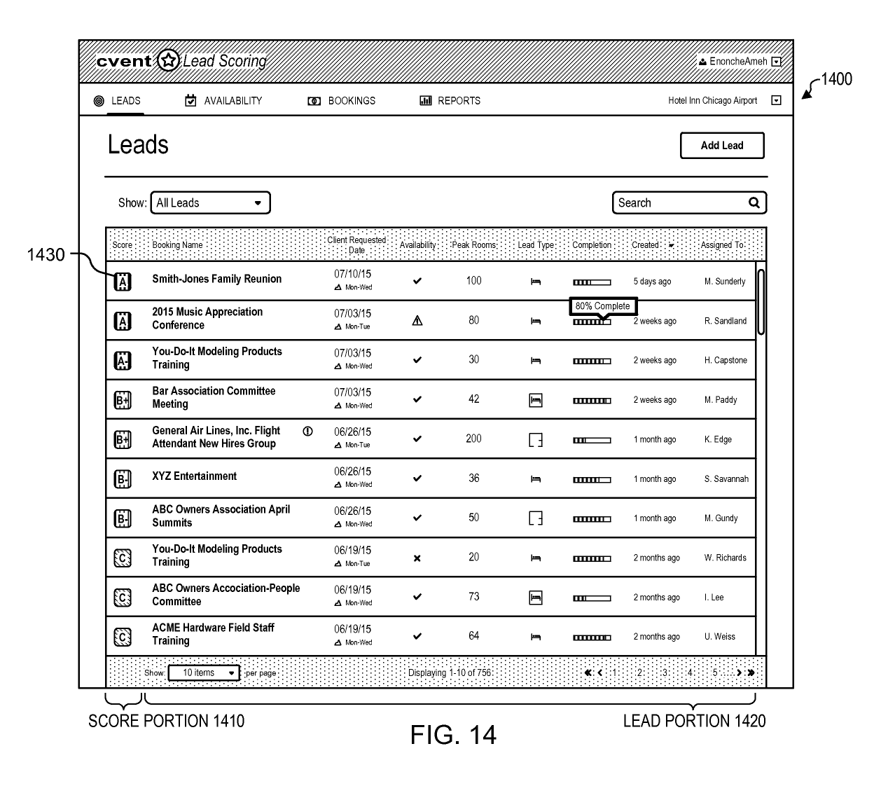

In another embodiment, the user interface object can comprise a simple visual indication such as a graphic that merely identifies the score. An example of such a user interface is shown by user interface 1400 in FIG. 14, in which lead portion 1420 (e.g., all columns of each row except for the leftmost column) comprises content corresponding to a proposed group booking based on the received lead, and score portion 1410 (e.g., the leftmost column of each row) comprises a user interface object (e.g., graphic 1430) specifying the generated lead score (e.g., letter grades “A,” “A-”, “B+”, “B−” and “C” as shown in the graphics in score portion 1410). Graphic 1430 relates to the “Smith-Jones Family Reunion” lead at the “Hotel Inn Chicago Airport”.

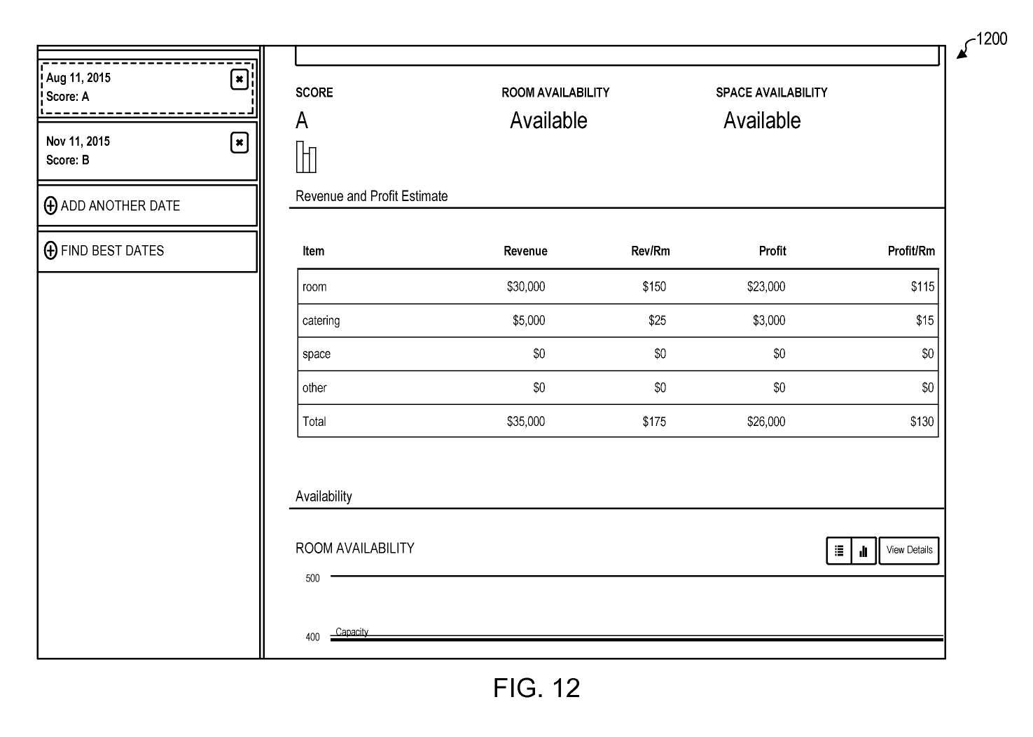

FIGS. 8-16 illustrates examples of lead management user interfaces. FIG. 8 shows user interface 800 that allows a user to set one or more components of each of multiple predefined scoring strategies for scoring leads. In this embodiment the scoring components comprise size of booking, profitability of booking and property (e.g., hotel) fit weightings. The weighting for each component is represented on a scale from 1 to 10 (10 being the highest), and the user can adjust the weighting by clicking and dragging the vertical slider bar across the scale to the desired weighting. The user interfaces provides different preconfigured strategies (“Large,” “Profitable,” “Best Fit,” “Balanced” and “Custom”) whose component weightings can be adjusted by the user.

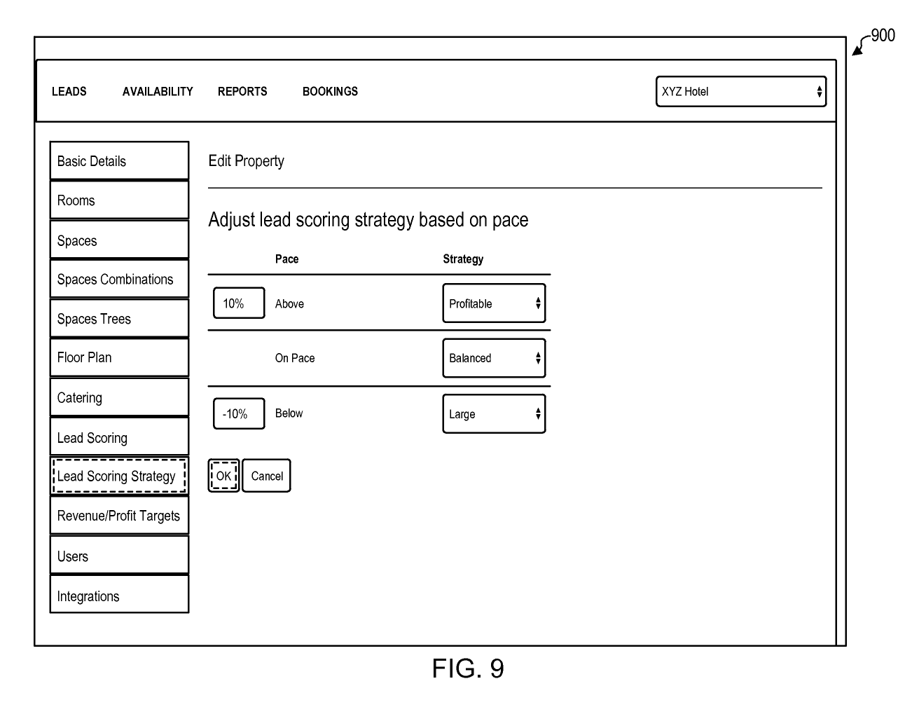

FIG. 9 shows a user interface that allows a user to adjust lead scoring based on pace of inventory booking relative to plan. The user interface allows the user to adjust what strategy (e.g., “Large,” “Profitable,” “Best Fit,” “Balanced” and “Custom”) is to be applied to scoring a lead that depends on a specified current pace of inventory booking relative to plan (e.g., on pace or a particular percentage ahead or behind pace for a given lead being currently evaluated/scored).

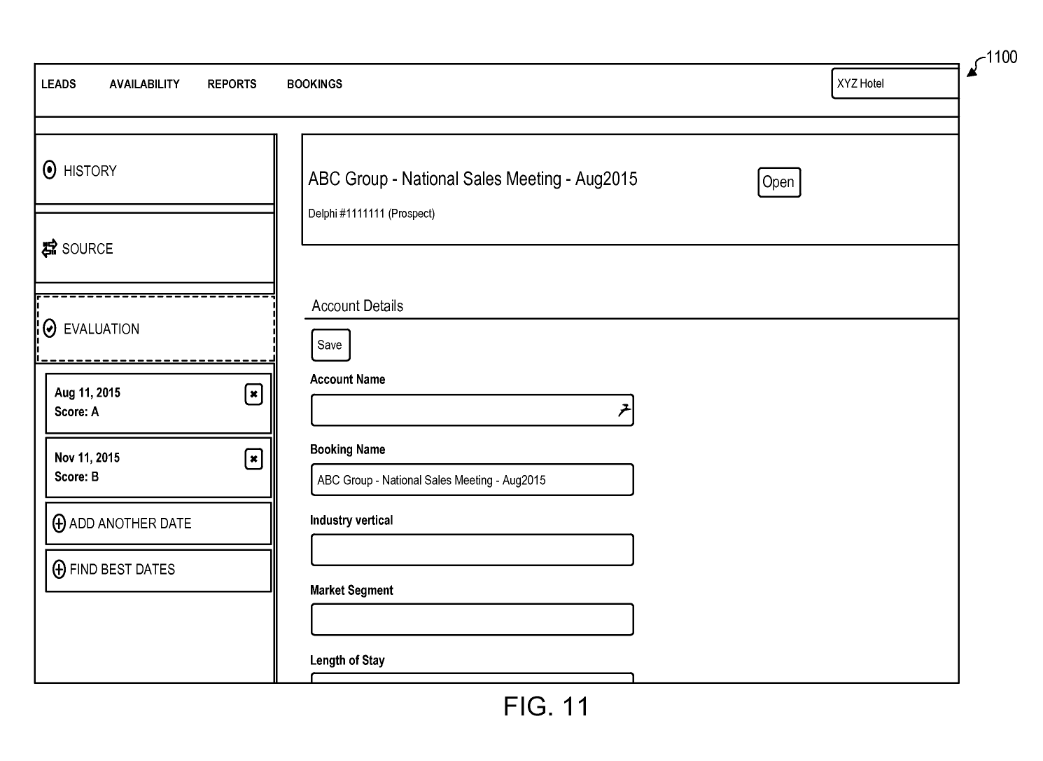

FIG. 10 shows user interface 1000 that displays multiple leads received and scored by lead management engine 105. FIGS. 11-13 show user interfaces 1100, 1200 and 1300, respectively, that allow a user to evaluate what-if scenarios with respect to the “ABC Group” lead. User interface 11 shows two options on the left panel of the screen (an “Aug. 11, 2015” option and a “Nov. 11, 2015” option) and a corresponding lead score for each one (“A” for the first option and “B” for the second option). User interface 1200 displays the details of a particular lead that is being evaluated, and the details comprise “Revenue and Profit Estimate” data and availability relative to capacity. User interface 1300 displays the layout corresponding to the event space as described above.

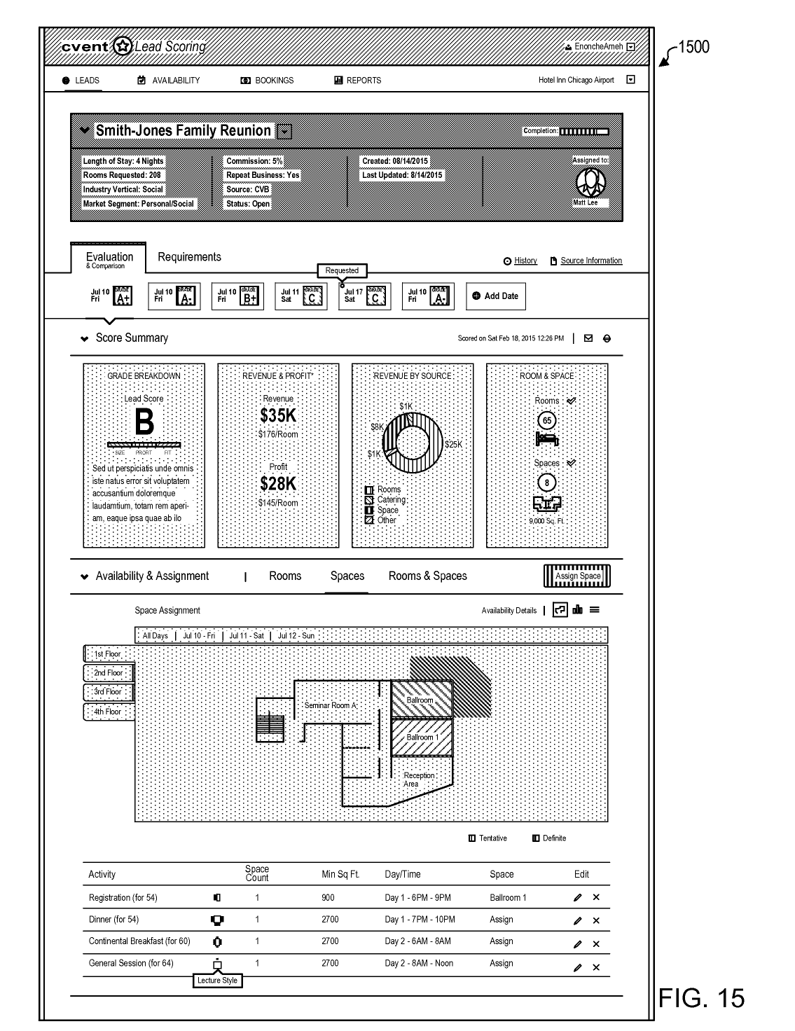

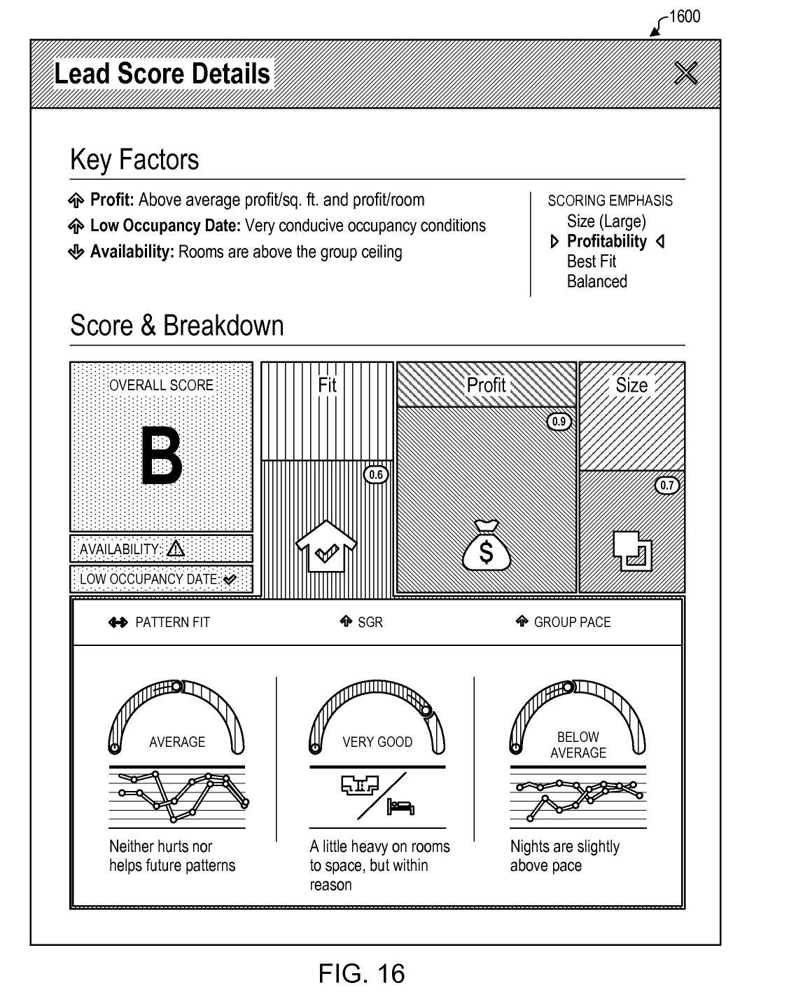

In another embodiment, FIG. 14 shows user interface 1400 that displays multiple leads received and scored by lead management engine 105. FIG. 15 and FIG. 16 show user interfaces 1500 and 1600, respectively, that allows a user to evaluate what-if scenarios with respect to the “Smith-Jones Family Reunion” lead. User interface 15 shows six options on the top “Evaluation and Comparison” panel of the screen (four “July 10” options, one “July 11” option and a “July 17” option) and a corresponding lead score for each one (“A+”, “A−”, “B+” and “A−” for the “July 10” options; and “C” for the “July 11” and “July 17” options). User interface 1500 also displays the “Availability & Assignment”, “Rooms”, “Spaces” (e.g., layout corresponding to the event space—“Space Assignment”—as described above) and “Rooms & Spaces” associated with the lead in the same user interface for ease of viewing. User interface 1600 displays the details of a particular lead that is being evaluated, and the details comprise a “Key Factors” explanation, current scoring strategy (“Scoring Emphasis”), and “Score & Breakdown” data including “Fit”, “Profit”, “Size”, “Pattern Fit”, “SGR” and “Group Pace”.

It is noted that although lead management platform 100 can be configured to provide the functionality disclosed in all of the embodiments of FIGS. 2 and 4-7, lead management platform 100 can also be configured to provide the functionality disclosed in each of embodiments of FIGS. 2 and 4-7 to the exclusion of the others. Further, the use of the term “sales person” and sales people” in this disclosure is meant to describe one possible type of user of lead management platform 100 and is not intended to limit the type of user capable of utilizing lead management platform 100 in any way.

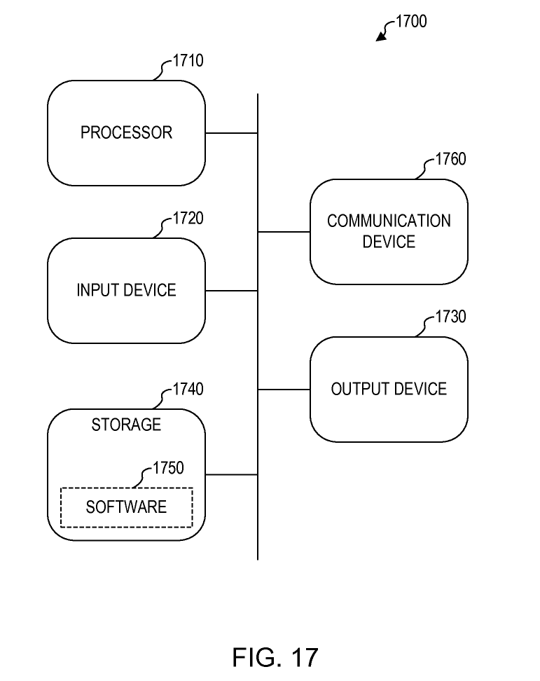

FIG. 17 shows a block diagram of an example of a computing device, which may generally correspond to one or more components of the lead management platform disclosed above (i.e., lead management engine 105). The form of computing device 1700 may be widely varied. For example, computing device 1700 can be a server, workstation, personal computer, handheld computing device, or any other suitable type of microprocessor-based device (e.g., a general purpose computer programmed or otherwise particularly configured to carry out the functionality of the lead management platform disclosed above. Computing device 1700 can include, for example, one or more components including processor 1710, input device 1720, output device 1730, storage 1740, and communication device 1760. These components may be widely varied, and can be connected to each other in any suitable manner, such as via a physical bus, network line or wirelessly for example.

For example, input device 1720 may include a keyboard, mouse, touch screen or monitor, voice-recognition device, or any other suitable device that provides input. Output device 1730 may include, for example, a monitor, printer, disk drive, speakers, or any other suitable device that provides output.

Storage 1740 may include volatile and/or nonvolatile data storage, such as one or more electrical, magnetic or optical memories such as a RAM, cache, hard drive, CD-ROM drive, tape drive or removable storage disk for example. Communication device 1760 may include, for example, a wired or wireless network interface or any other suitable device capable of transmitting and receiving signals over a network.

Network 140 may include any suitable interconnected communication system, such as a local area network (LAN) or wide area network (WAN) for example. The network may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 1750 can be stored in storage 1740 and executed by processor 1710 which may include one or more processors. Software 1750 may include, for example, programming that embodies the functionality described in the various embodiments of the present disclosure such as that embodied by the lead management platform disclosed above. The programming may take any suitable form. Software 1750 may include, for example, a combination of servers such as application servers and database servers.

Software 1750 can also be stored and/or transported within any computer-readable storage medium for use by or in connection with an instruction execution system, apparatus, or device, such as computing device 1700 for example, that can fetch instructions associated with the software from the instruction execution system, apparatus, or device and execute the instructions. In the context of this document, a computer-readable storage medium can be any medium, such as storage 1740 for example, that can contain or store programming for use by or in connection with an instruction execution system, apparatus, or device.

Software 1750 can also be propagated within any transport medium for use by or in connection with an instruction execution system, apparatus, or device, such as computing device 1700 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

It will be appreciated that the above description for clarity has described embodiments of the disclosure with reference to different functional units and processors. However, it will be apparent that any suitable distribution of functionality between different functional units or processors may be used without detracting from the disclosure. For example, functionality illustrated to be performed by separate engines, such as lead management engine 105 and sales engine 125, may be performed by the same engine, and functionality illustrated to be performed by the same engine may be performed by separate engines. Hence, references to specific functional units may be seen as references to suitable means for providing the described functionality rather than indicative of a strict logical or physical structure or organization.

The disclosure may be implemented in any suitable form, including hardware, software, firmware, or any combination of these. The disclosure may optionally be implemented partly as computer software running on one or more data processors and/or digital signal processors. The elements and components of an embodiment of the disclosure may be physically, functionally, and logically implemented in any suitable way. Indeed, the functionality may be implemented in a single unit, in multiple units, or as part of other functional units. As such, the disclosure may be implemented in a single unit or may be physically and functionally distributed between different units and processors.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A computer system comprising:
one or more memories storing instructions; and
one or more processors configured to execute the instructions to cause the system to:
receive a listing of inventory associated with one or more properties,
receive a lead over a network, the lead specifying an interest in a group booking of at least a portion of the inventory,
generate, in response to the received lead, one or more proposed group bookings based on the received listing without blocking the inventory associated with the one or more proposed group bookings, and
display the generated one or more proposed group bookings via a user interface.

2. The computer system of claim 1, wherein the one or more processors are configured to execute the instructions to cause the system to:
receive a change to the lead via the user interface, and
automatically in response to the received change:
generate one or more updated proposed group bookings based on the changed lead without blocking the inventory associated with the one or more updated proposed group bookings, and
display the generated one or more updated proposed group bookings via the user interface.

3. The computer system of claim 1, wherein the one or more processors are configured to execute the instructions to cause the system to:
receive an update to the listing of inventory, and
automatically in response to the received update:
generate one or more updated proposed group bookings based on the updated listing without blocking the inventory associated with the one or more updated proposed group bookings, and
display the generated one or more updated proposed group bookings via the user interface.

4. The computer system of claim 1, wherein the one or more processors are configured to execute the instructions to cause the system to:
generate, in response to the received lead, a proposed group booking based on the received listing that blocks the inventory associated with the proposed group booking, and
display the generated group booking via the user interface.

5. A computer system comprising:
one or more memories storing instructions; and
one or more processors configured to execute the instructions to cause the system to:
receive data associated with inventory associated with one or more properties,
calculate, based on the received data, pacing data specifying an extent to which the inventory is booked relative to plan,
receive a lead over a network, the lead specifying an interest in a group booking of at least a portion of the inventory,
generate, in response to the received lead, a score for the received lead based on a preconfigured scoring strategy comprising the received pacing data, and
display the generated score via a user interface.

6. The computer system of claim 5, wherein the one or more processors are configured to execute the instructions to cause the system to:
receive a change to the scoring strategy via the user interface, and
automatically in response to the received change:
generate an updated score for the received lead based on the changed scoring strategy, and
display the generated updated score via the user interface.

7. The computer system of claim 5, wherein the one or more processors are configured to execute the instructions to cause the system to:
receive an update to the data associated with the inventory,
re-calculate the pacing data, and
automatically in response to the re-calculated pacing data:
generate an updated score for the received lead based on the re-calculated pacing data, and
display the generated updated score via the user interface.

8. The computer system of claim 5, wherein the scoring strategy comprises a size of booking weighting, profitability of booking weighting and a property fit weighting.

9. The computer system of claim 8, wherein the scoring strategy further comprises other variable weightings including one or both of availability and low occupancy.

10. A computer system comprising:
one or more memories storing instructions; and
one or more processors configured to execute the instructions to cause the system to:
receive a lead over a network, the lead specifying an interest in a group booking of at least a portion of inventory associated with one or more properties,
compare the received lead against a historical booking pattern associated with the one or more properties,
generate a score for the received lead based on the comparison of the received lead against the historical booking pattern, and
display the generated score via a user interface.

11. The computer system of claim 10, wherein the one or more processors are configured to execute the instructions to cause the system to:
receive a change to a scoring strategy via the user interface, and
automatically in response to the received change:
generate an updated score for the received lead based on the changed scoring strategy, and
display the generated updated score via the user interface.

12. The computer system of claim 10, wherein the one or more processors are configured to execute the instructions to cause the system to:
receive an update to the historical booking pattern, and
automatically in response to the received update:
generate an updated score for the received lead based on the updated historical booking pattern, and
display the generated updated score via the user interface.

13. The computer system of claim 10, wherein the historical booking pattern comprises probabilities associating group bookings of distinct sizes with distinct days of the week.

14. A computer system comprising:
one or more memories storing instructions; and
one or more processors configured to execute the instructions to cause the system to:
receive a lead over a network, the lead specifying an interest in a group booking of at least a portion of event space associated with one or more properties,
determine a mapping of one or more events associated with the group booking to one or more units of the event space;
display the generated mapping via a user interface.

15. The computer system of claim 14, wherein the one or more processors are configured to execute the instructions to cause the system to:
receive a change to the mapping via the user interface, and
generate a proposed group booking based on the changed mapping.

16. The computer system of claim 14, wherein the received lead fails to specify an amount of event space for the group booking, and wherein the one or more processors are configured to execute the instructions to cause the system to:
in response to the received lead:
compare the received lead against a historical booking pattern associated with the one or more properties,
generate an amount of event space for the group booking based on the comparison of the received lead against the historical booking pattern, and
modify the lead to comprise the generated amount of event space.

17. The computer system of claim 14, wherein the displayed user interface comprises:
a layout corresponding to the event space, and
one or more user interface objects associated with the mapped one or more units of the event space.

18. A method comprising:
receiving, by one or more processors, a lead over a network, the lead specifying an interest in a group booking of at least a portion of inventory associated with one or more properties,
generating, by one or more processors and in response to the received lead, a score for the received lead based on a scoring strategy comprising multiple components, and
displaying, by one or more processors, a user interface comprising:
a first portion comprising content corresponding to a proposed group booking based on the received lead, and
a second portion comprising a user interface object corresponding to the multiple components of the generated score.

19. The method of claim 18, wherein the user interface object comprises a graph.

20. The method of claim 19, wherein the graph comprises a bar graph, wherein each bar of the graph corresponds to a distinct one of the multiple components, and wherein a height of each bar indicates an extent of the score relative to its respective component.

21. The method of claim 18, wherein the user interface object comprises a geometric shape corresponding to a distinct one of the multiple components, and wherein a color, pattern or type of each geometric shape indicates an extent of the score relative to its respective component.

22. The method of claim 18, wherein the user interface object comprises a graphic specifying the generated score.
